(19) United States
(12) Patent Application Publication
(10) Pub. No.: US 2024/0368318 A1
(43) Pub. Date: Nov. 7, 2024

(54) REINFORCED SHAPED ARTICLES COMPRISING FLUOROPOLYMERS

(71) Applicant: SOLVAY SPECIALTY POLYMERS ITALY S.P.A., Bollate (Milano) (IT)

(72) Inventors: Mirko Mazzola, Milano (MI) (IT); Emanuele Di Nicolo', Gorla Minore (VA) (IT); Giulio Brinati, Milano (MI) (IT); Rosita Lissette Pena Cabrera, Bergamo (BG) (IT); Andrea Vittorio Oriani, Milano (MI) (IT)

(73) Assignee: SOLVAY SPECIALTY POLYMERS ITALY S.P.A., Bollate (Milano) (IT)

(21) Appl. No.: 18/291,476

(22) PCT Filed: Jul. 19, 2022
(86) PCT No.: PCT/EP2022/070185

§ 371 Date: Jan. 23, 2024

(30) Foreign Application Priority Data
Jul. 23, 2021 (EP) 21187478.9

(51) Int. Cl. C08F 214/22; C08F 2/22; C08F 2/38; C08F 220/06; C08K 3/04; C08K 3/22; H01M 4/04; H01M 4/1391; H01M 4/62

(52) U.S. Cl. CPC C08F 214/22; C08F 2/22; C08F 2/38; C08F 220/06; C08K 3/04; C08K 3/22; H01M 4/0471; H01M 4/1391; H01M 4/623; C08K 2201/001

(57) ABSTRACT

The present invention pertains to a method for making a reinforced shaped article comprising the steps of: a) providing one or more fluoropolymers having a melting point Tm, said one or more fluoropolymers being characterized in that they: (i) comprise more than 30% by moles of recurring units derived from VDF, with respect to the total number of recurring units of the polymer; (ii) have iodine-containing chain ends —CH₂I in an amount of 0.1 to 0.9 per chain; b) dissolving said fluoropolymer in a suitable solvent and forming a precursor solution c) precipitating said fluoropolymer as a solid from said precursor solution thereby obtaining a shaped article comprising said fluoropolymer e) thermally treating said shaped article for at least 15 minutes at a temperature comprised between 100° C. and the lowest melting point Tm of said one or more fluoropolymers thereby obtaining said reinforced shaped article.

### TECHNICAL FIELD

This application claims priority to the European Patent Application Nr 21187478.9 filed on 23 Jul. 2021. The whole content of this application being incorporated herein by reference for all purposes.

The present invention pertains to a method for making shaped articles comprising selected vinylidene fluoride (VDF) based fluoropolymers, the articles being reinforced, after having been formed, by a thermal treatment in controlled conditions. Shaped articles comprising the selected fluoropolymers can first be formed using solvent processing techniques and can then be reinforced with a simple thermal treatment. The resulting article, after the thermal treatment, is reinforced in that it has enhanced mechanical properties and in some cases also other advantageous properties such as improved adhesion on substrates. The method of the invention can be applied for example in the manufacturing of electrochemical cell components, such as electrodes or for the manufacture of membranes, in particular porous membranes.

### BACKGROUND ART

When manufacturing shaped articles comprising fluoropolymers, particularly VDF based fluoropolymers, it is often desirable to achieve good mechanical properties. On the other hand, for an easier manufacturing of shaped articles, it is typically desirable to select VDF based fluoropolymers which are easier to handle either using melt processing techniques or solvent processing techniques. For easier melt processing, it is typically desirable that a fluoropolymer is thermoplastic and has a relatively low melting point and a relatively low viscosity of the melt, so that it can be molded and/or extruded at relatively low temperatures and pressures providing shaped articles having a smooth surface finish and which are free from defects. Similarly when using solvent processing techniques, wherein the polymer is dissolved in solution with an appropriate solvent and then is precipitated from the solution in its final form such as e.g. in solvent casting techniques used for example to make films, membranes or coatings including electrode coatings, it is desirable that the polymer is easy to dissolve in conventional solvents.

These desirable properties which allow easier processing of the material are, in general, in contradiction with the obtainment of good mechanical properties in the finished product, i.e., for a given class of polymers, in general, the lower is the melting point, the lower is the viscosity of the melt, the higher is the solubility of the fluoropolymer, the lower are the mechanical properties of the resulting product.

In order to resolve this issue, attempts have been made in the art to form shaped articles using polymers which are easy to process but introducing into these polymers selected terminals which can then be crosslinked by adding a cross linker or a radical initiator in the compositions.

While this method is effective and is used industrially in many circumstances, it cannot be applied to all circumstances because it typically generates highly cross linked materials which are not suitable for many applications and which have properties significantly different from the starting polymers. Also fully cross linked polymers are in general not thermoplastic anymore which also makes their recycling or re-use more difficult.

There is therefore a need for a method for reinforcing articles made out of polymers which are easy to process and which do not have these drawbacks.

### SUMMARY OF INVENTION

In one aspect the present invention relates to a method of making a reinforced shaped article said method comprising the steps of:
a) providing one or more fluoropolymers having a melting point Tm, said one or more fluoropolymers being characterized in that they:
   (i) comprise more than 30% by moles of recurring units derived from VDF, with respect to the total number of recurring units of the polymer;
   (ii) have iodine-containing chain ends —CH₂I in an amount of 0.1 to 0.9 per chain;
b) dissolving said fluoropolymer in a suitable solvent and forming a precursor solution
c) precipitating said fluoropolymer as a solid from said precursor solution thereby obtaining a shaped article comprising said fluoropolymer
e) thermally treating said shaped article for at least 15 minutes at a temperature comprised between 100° C. and the lowest melting point Tm of said one or more fluoropolymers thereby obtaining said reinforced shaped article.

In other aspects the present invention relate to an electrode coating and to a filtration membrane obtainable with the method of the present invention.

### DETAILED DESCRIPTION OF THE INVENTION

The present invention pertains to a method of making a reinforced shaped article comprising selected fluoropolymers.

The term “shaped article” has to be intended in broad sense as a solid article which has a shape. This includes articles having a three dimensional shape, including hollow shapes, and also articles which are essentially planar such as films. Also fibers and hollow fibers are considered examples of “shaped articles”. A coating is also considered as a “shaped article” in the context of the present invention, although the substrate of the coating is not considered part of the “shaped article”.

According to the present invention such shaped article is first formed, i.e. a solid article having a defined shape is obtained from a composition comprising the selected fluoropolymers, and then, in a subsequent step, said shaped article is reinforced by subjecting it to a thermal treatment as it will be described in detail below, thus obtaining a reinforced shaped article. The thermal treatment, is performed at a temperature below the melting point of the polymer (or below the melting point of the lowest melting polymer in case a polymer blend is used) and therefore it does not melt the shaped article. Even without melting in some cases the shaped article may partially change its shape as a consequence of the thermal treatment (e.g. shrink), therefore the shape of the “reinforced shaped article” of the invention may be different from the shape of the “shaped article” when formed in the first place, i.e. before the thermal treatment. As an example a rectangular film having certain dimensions, as a consequence of the thermal treatment, may shrink along one or more dimensions.

As mentioned above, the reinforced shaped article of the invention is manufactured from a composition comprising one or more selected fluoropolymers. Such one or more selected fluoropolymers have the following features:
(i) comprise more than 30%, preferably more than 50%, more preferably more than 70%, even more preferably more than 85% moles of recurring units derived from VDF, with respect to the total number of recurring units of the polymer;
(ii) have iodine-containing chain ends —CH₂I in an amount of 0.1 to 0.9 preferably from 0.3 to 0.7 per chain;
(iii) preferably have a weight averaged molecular weight (Mw) of at least 200 KDalton, preferably at least 300 KDalton, more preferably at least 400 KDalton, even more preferably at least 500 KDalton, most preferably at least 600 KDalton, when measured by GPC, using N, N-dimethylacetamide (DMA) as solvent, against monodisperse polystyrene standards.

The selected fluoropolymers of the invention may further comprise recurring units derived from at least one other comonomer different from VDF. Such comonomer can be either a hydrogenated comonomer or a fluorinated comonomer.

By the term “hydrogenated comonomer, it is hereby intended to denote an ethylenically unsaturated comonomer free of fluorine atoms.

Non-limitative examples of suitable hydrogenated comonomers include, notably, ethylene, propylene, vinyl monomers such as vinyl acetate, as well as styrene monomers, like styrene and p-methylstyrene.

The hydrogenated comonomer may be a monomer comprising at least one polar group selected from the group consisting of hydroxyl groups, carboxylic acid groups, epoxy groups.

According to certain preferred embodiments, the hydrogenated monomer can be selected from hydrophilic (meth)acrylic monomers of formula:

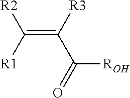

wherein each of R₁, R₂, R₃, equal or different from each other, is independently an hydrogen atom or a C₁-C₃ hydrocarbon group, and R_{OH} is a hydroxyl group or a C₁-C₅ hydrocarbon moiety comprising at least one hydroxyl group.

More preferably R₃ is hydrogen; even more preferably, each of R₁, R₂, R₃ are hydrogen.

Non limitative examples of hydrophilic (meth)acrylic monomers are notably acrylic acid, methacrylic acid, hydroxyethyl (meth)acrylate, hydroxypropyl (meth)acrylate; hydroxyethylhexyl (meth)acrylates.

The hydrophilic (meth)acrylic monomer is more preferably selected among:
hydroxyethylacrylate (HEA) of formula:

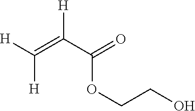

2-hydroxypropyl acrylate (HPA) of either of formulae:

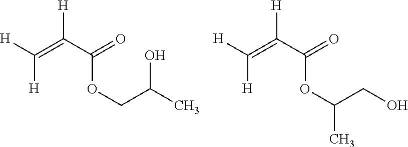

acrylic acid (AA) of formula:

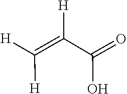

and mixtures thereof.

More preferably, the hydrophilic (meth)acrylic monomers is AA and/or HEA, even more preferably is AA.

Determination of the amount of hydrophilic (meth)acrylic monomers in the fluoropolymer of the invention can be performed by any suitable method. Mention can be notably made of acid-base titration methods, well suited e.g. for the determination of the acrylic acid content, of NMR methods, adequate for the quantification of (meth)acrylic monomers comprising aliphatic hydrogens in side chains (e.g. HPA, HEA), of weight balance based on total fed of (meth)acrylic monomers and unreacted residual (meth)acrylic monomers during manufacture of the fluoropolymer.

In case one or more of the selected fluoropolymers of the invention comprise recurring units derived from hydrophilic (meth)acrylic monomers their amount is preferably at least 0.1%, more preferably at least 0.2% moles and/or at most 10%, more preferably at most 7.5% by moles, even more preferably at most 5% moles, most preferably at most 3% moles.

By the term “fluorinated comonomer”, it is hereby intended to denote an ethylenically unsaturated comonomer comprising at least one fluorine atom. Non-limitative examples of suitable fluorinated comonomers include, the following:
(a) C₂-C₈ fluoro- and/or perfluoroolefins such as tetrafluoroethylene (TFE), hexafluoropropylene (HFP), pentafluoropropylene and hexafluoroisobutylene;
(b) C₂-C₈ hydrogenated monofluoroolefins such as vinyl fluoride, 1,2-difluoroethylene and trifluoroethylene;
(c) perfluoroalkylethylenes of formula CH₂═CH—R_{f0}, wherein R_{f0} is a C₁-C₆ perfluoroalkyl group;
(d) chloro- and/or bromo- and/or iodo-C₂-C₆ fluoroolefins such as chlorotrifluoroethylene (CTFE);
(e) (per)fluoroalkylvinylethers of formula CF₂═CFOR_{f1}, wherein R_{f1} is a C₁-C₆ fluoro- or perfluoroalkyl group, e.g. —CF₃, —C₂F₅, —C₃F₇;
(f) (per)fluoro-oxyalkylvinylethers of formula CF₂═CFOX₀, wherein X₀ is a C₁-C₁₂ oxyalkyl group or a C₁-C₁₂ (per)fluorooxyalkyl group having one or more ether groups, e.g. perfluoro-2-propoxy-propyl group;
(g)fluoroalkyl-methoxy-vinylethers of formula CF₂═CFOCF₂OR₂, wherein R_{f2} is a C₁-C₆ fluoro- or perfluoroalkyl group, e.g. —CF₃, —C₂F₅, —C₃F₇ or a C₁-C₆ (per)fluorooxyalkyl group having one or more ether groups, e.g. —C₂F₅—O—CF₃;
(h) fluorodioxoles of formula:

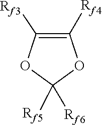

wherein each of R_{f3}, R_{f4}, R_{f5} and R_{f6}, equal to or different from each other, is independently a fluorine atom, a C₁-C₆ fluoro- or per (halo)fluoroalkyl group, optionally comprising one or more oxygen atoms, e.g. —CF₃, —C₂F₅, —C₃F₇, —OCF₃, —OCF₂CF₂OCF₃.

Most preferred fluorinated comonomers are tetrafluoroethylene (TFE), trifluoroethylene (TrFE), chlorotrifluoroethylene (CTFE), hexafluoropropylene (HFP), perfluoromethyl vinyl ether (PMVE), perfluoropropyl vinyl ether (PPVE) and vinyl fluoride, and among these, HFP is most preferred.

Should at least one comonomer (preferably HFP) be present, the polymer comprises typically from 0.05% to 14.5% by moles, preferably from 1.0% to 13.0% by moles, of recurring units derived from said comonomer(s), with respect to the total moles of recurring units of the fluoropolymer.

As mentioned above the content of recurring units derived from VDF in the selected fluoropolymers of the invention is more than 30%, preferably more than 50%, more preferably more than 70%, even more preferably more than 85%. The method of the invention can be applied to a vast range of materials, however fluoropolymers having a higher amount of recurring units derived from VDF is preferred, for certain applications. In some embodiments the amount of recurring units derived from vinylidene fluoride in the fluoropolymer is at least 85 mol %, preferably at least 86 mol %, more preferably at least 87 mol %, so as not to impair the excellent properties of vinylidene fluoride resin, such as chemical resistance, weatherability, and heat resistance. For instance, in some cases when such fluoropolymers comprises an amount of VDF units of less than 85 mol %, they may dissolve in certain solvents such as for example those used in an electrolyte liquid phase in a secondary battery.

According to certain embodiments, the fluoropolymer of the invention consists essentially of recurring units derived from VDF, and from hydrophilic (meth)acrylic monomers as defined above.

According to other embodiments, the fluoropolymer of the invention consists essentially of recurring units derived from VDF, from HFP and, optionally, from hydrophilic (meth)acrylic monomers as defined above.

The expression “consists essentially” when used in connection with recurring units of the fluoropolymer of the invention is understood to mean that defects, end chains and impurities may be present in the fluoropolymer of the invention in addition to the listed recurring units, without this substantially affecting the advantageous features of the fluoropolymer.

In general the selected fluoropolymers of the invention may still comprise other moieties such as defects, end-groups and the like, which do not affect nor impair its physico-chemical properties.

The fluoropolymer of the invention preferably possesses a weight averaged molecular weight (Mw) of at least 200 KDalton, preferably at least 300 KDalton, more preferably at least 400 KDalton, even more preferably at least 500 KDalton, most preferably at least 600 KDalton, when measured by GPC, using N, N-dimethylacetamide (DMA) as solvent, against monodisperse polystyrene standards. Upper boundaries for Mw are not particularly critical, it is however preferred that the selected fluoropolymers of the invention have a Mw of at most 1400 KDalton, preferably at most 1300 KDalton, more preferably of at most 1200 KDalton, even more preferably of at most 1100 KDalton, most preferably of at most 1000 KDalton, when measured by GPC in the same way.

As mentioned above, the fluoropolymers of the invention are characterized by comprising a controlled amount of iodine-containing chain ends —CH₂I. Specifically the fluoropolymers of the invention have iodine-containing chain ends —CH₂I in an amount of 0.1 to 0.9 preferably from 0.3 to 0.7 per chain of polymer.

The presence of iodine-containing chain ends —CH₂I is the fingerprint due to the use of iodine-containing chain transfer agent in emulsion polymerization. This manufacturing process which leads to the formation of an aqueous dispersion of the fluoropolymers of the invention is described in WO2020/126449 to Solvay Specialty Polymers S.p.A.

Generally, said chain ends are chain ends of formula —CH₂I.

Concentration of iodine containing chain ends —CH₂I can be determined by 1H-NMR, according to the techniques detailed in PIANCA, M., et al. End groups in fluoropolymers. Journal of Fluorine Chemistry. 1999, vol. 95, p. 71-84., in substantially analogous manner as per the determination of —CF₂—CH₂Br or —CF₂—CH₂OH end groups, considering the chemical shift of —CH₂I.

The described NMR method provides information on the concentration of iodine containing chain ends —CH₂I in mmol/Kg, this value can be converted into the amount of iodine containing chain ends —CH₂I per polymer chain combining it with information on the molecular weight distribution which can be measured via GPC as described above. The described GPC method provides both the weight average molecular weight (Mw) and the number average molecular weight (Mn), which is the value needed to convert the value of Iodine content from mmol/Kg to iodine containing chain ends per polymer chain.

According to certain preferred embodiments, the selected fluoropolymers of the invention are substantially free from fluorinated surfactants.

According to certain preferred embodiments, the selected fluoropolymers of the invention are manufactured via radical polymerization in an aqueous environment, preferably via emulsion polymerization, wherein the polymerization medium is preferably substantially free from fluorinated surfactants. As mentioned above suitable selected fluoropolymers for use in the present invention can be prepared according to the procedure described in WO2020/126449 to Solvay Specialty Polymers S.p.A.

The expression “substantially free” when referred to with the amount of fluorinated surfactants in the reaction medium is to be meant to exclude the presence of any significant amount of said fluorinated surfactants, e.g. requiring the fluorinated surfactants to be present in an amount of less than 5 ppm, preferably of less than 3 ppm, more preferably of less than 1 ppm, with respect to the total weight of the reaction medium.

Similarly the expression “substantially free”, when referred to the amount of fluorinated surfactants in the fluoropolymer, is to be meant to exclude the presence of any significant amount of said fluorinated surfactants, e.g. requiring the fluorinated surfactants to be present in an amount of less than 5 ppm, preferably of less than 3 ppm, more preferably of less than 1 ppm, with respect to the total weight of the fluoropolymer.

Advantageously the selected fluoropolymers of the invention comprise a relatively low fraction of insoluble gels as measured with the gel content test described in the experimental section. Such gel content is preferably below 20%, preferably below 10%, more preferably below 5%, even more preferably below 3% by weight based on the total weight of the fluoropolymers.

As mentioned above, the fluoropolymers of the invention can be manufactured with a method comprising emulsion polymerization in an aqueous environment in the presence of one or more radical initiator and one or more iodine-containing chain transfer agent.

Generally, for embodiments whereas no fluorosurfactant is added, inorganic radical initiators will be preferred, due to their ability of generating polar chain ends having a stabilizing effect on particles of the fluoropolymer in the dispersion. Persulfate radical initiators are generally those most used to this aim.

While the choice of the persulfate radical initiator is not particularly limited, it is understood that radical initiators suitable for an aqueous emulsion polymerization process are selected from compounds capable of initiating and/or accelerating the polymerization process in aqueous environment and include, but are not limited to, sodium, potassium and ammonium persulfates.

One or more radical initiators as defined above may be added to the aqueous medium as defined above in an amount ranging advantageously from 0.001% to 20% by weight based on the weight of the aqueous medium.

As said, in the manufacturing method for the selected fluoropolymers of the present invention, an iodine-containing chain transfer agent is added. Iodine-containing chain transfer agents are selected generally from the group consisting of:
iodinated hydrocarbon agent(s) of formula R_{H}(I)ₓ, in which R_{H} is a fluorine-free alkyl group containing from 1 to 8 carbon atoms, and x is an integer between 0 and 2: an example thereof is CH₂I₂;
iodinated fluorocarbon agent(s) of formula R_{f}(I)ₓ, in which R_{f} is a (per)fluoroalkyl or a (per)fluorochloroalkyl containing from 1 to 8 carbon atoms, and x is an integer between 0 and 2; an example thereof is diiodoperfluorobutane of formula C₄F₈I₂; and
alkali metal or alkaline-earth metal iodides, such as described notably in patent U.S. Pat. No. 5,173,553 (AUSIMONT SRL) Dec. 22, 1992. Potassium iodide has been found particularly effective as iodine-chain transfer agent in the method of the invention.

The molar ratio between the said iodine-containing chain transfer agent and the said initiator is of less than 0.12 mol/mol, preferably at most 0.10, more preferably at most 0.09 mol/mol. The Applicant has surprisingly found that such low amount of iodine-containing chain transfer agent is effective in promoting pseudo-living character to the polymerization while enabling achieving high molecular weight and avoiding any modification in the final polymer performances.

While the lower boundaries for the said iodine-containing chain transfer agent is not particularly limited, the same is generally used in an amount such to provide for a molar ratio between the said iodine-containing chain transfer agent and the said initiator of at least 0.015, preferably at least 0.03, more preferably at least 0.06 mol/mol.

As said, the method is preferably carried out with no addition of a fluorinated surfactant. For “fluorinated surfactant” in the present invention it is intended a material complying with the following formula:

R_{f§}(X⁻)ₖ(M⁺)ₖ
wherein:
   R_{f§} is selected from a C₅-C₁₆ (per)fluoroalkyl chain, optionally comprising one or more catenary or non-catenary oxygen atoms, and a (per)fluoropolyoxyalkyl chain,
   X is selected from —COO—, —PO₃— and —SO₃,
   M⁺ is selected from NH₄⁺ and an alkaline metal ion, and
   k is 1 or 2.

Non-limitative examples of fluorinated surfactants whose presence is substantially avoided in the reaction medium are the followings:
(a) CF₃(CF₂)ₙ₀COOM′, wherein n₀ is an integer ranging from 4 to 10, preferably from 5 to 7, preferably n₁ being equal to 6, and M′ represents NH₄, Na, Li or K, preferably NH₄;
(b) T-(C₃F₆O)ₙ₁(CFXO)ₘ₁CF₂COOM″, wherein T represents a Cl atom or a perfluoroalkoxyde group of formula CₓF_{2x+1-x′}Cl_{x′}O, wherein x is an integer ranging from 1 to 3 and x′ is 0 or 1, n₁ is an integer ranging from 1 to 6, m₁ is an integer ranging from 0 to 6, M″ represents NH₄, Na, Li or K and X represents F or —CF₃;
(c) F—(CF₂CF₂) n₂—CH₂—CH₂—RO₃M″, in which R is a phosphorus or a sulphur atom, preferably R being a sulphur atom, M″ represents NH₄, Na, Li or K and n₂ is an integer ranging from 2 to 5, preferably n₂ being equal to 3;
(d) A-R_{bf}—B bifunctional fluorinated surfactants, wherein A and B, equal to or different from each other, have formula —(O)ₚCFX″—COOM*, wherein M* represents NH₄, Na, Li or K, preferably M* representing NH₄, X″ is F or —CF₃ and p is an integer equal to 0 or 1, and R_{bf} is a divalent (per)fluoroalkyl or (per)fluoropolyether chain such that the number average molecular weight of A-R_{bf}—B is in the range of from 300 to 1800; and
(e) mixtures thereof.

Typically the described emulsion polymerization method for the preparation of the fluoropolymer will provide for a water dispersion of fluoropolymer such as a latex. However, for use in the present invention the selected fluoropolymer is provided preferably as a solid such as in pellets or more preferably in a finely dispersed form, e.g. powder or granules. Most preferably the selected fluoropolymer of the invention can be provided in powder form.

The selected fluoropolymer powder may be obtained by known techniques from the fluoropolymer dispersion notably, by coagulation, e.g. shear or temperature-induced coagulation, or may be obtained by spray-drying or other drying or liquid/solid separation. Other solid polymer forms (such as granules or pellets) can be obtained from the powder using known techniques, however, as mentioned above, the powder form obtained from the dispersion via coagulation and/or spray drying is the most preferred form for providing the selected fluoropolymers for the invention because it is the form which can be solubilized more easily in a solvent thanks to its surface to volume ratio.

In fact, in a step of the method of the present invention, the one or more selected fluoropolymers are dissolved in a suitable solvent so to form a precursor solution.

Suitable solvents for the precursors solution are any solvent capable to solubilize the selected fluoropolymers of the invention. Since the selected fluoropolymers of the invention comprise a significant amount of VDF recurring units, all solvents which are known and commonly used for VDF based polymers and co-polymers can be used in the present invention. Such solvents are typically polar organic solvents which can preferably be selected from one or more than one of: N-methyl-2-pyrrolidone (commonly referred to as: NMP), N-butyl pyrrolidone, dimethylformamide, N,N-dimethylacetamide, N, N-dimethylsulfoxide, dihydrolevoglucosenone (Cyrene®), hexamethylphosphamide, dioxane, tetrahydrofuran, tetramethylurea, triethyl phosphate, and trimethyl phosphate. As the selected fluoropolymers used in the present invention have a relatively high molecular weight, more preferably the solvents are selected from nitrogen-containing organic solvents having a larger dissolving power, such as N-methyl-2-pyrrolidone, dimethylformamide or N, N-dimethylacetamide.

Other suitable solvents for the present invention are diesters of formula (I-_{de}), esteramides of formula (I-ₑₐ) and diamides of formula (I-_{da}):

R¹(O═)CO-A_{de}-OC(═O)R² (I-_{de})

R¹O(O═)C-Aₑₐ-C(═O)NR³R⁴ (I-ₑₐ)

R⁵R⁶N(O═)C-A_{da}-C(═O)NR⁵R⁶ (I-_{da})
wherein:
   R¹ and R², equal to or different from each other, are independently selected from the group consisting of C₁-C₂₀ hydrocarbon groups;
   R³, R⁴, R⁵ and R⁶, equal to or different from each other, are independently selected from the group consisting of hydrogen, C₁-C₃₆ hydrocarbon groups, possibly substituted, being understood that R³, R⁴, R⁵ and R⁶ might be part of a cyclic moiety including the nitrogen atom to which they are bound, said cyclic moiety being possibly substituted and/or possibly comprising one or more than one additional heteroatoms,
   A_{de} is a C₃-C₁₀ divalent alkylene group comprising one or more ether oxygen atoms,
   Aₑₐ and A_{da}, equal to or different from each other, are independently C₃-C₁₀ divalent alkylene groups, optionally comprising one or more ether oxygen atoms and/or one or more functional side groups.

All these organic solvents may be used singly or in mixture of two or more species.

To note, depending on the type of article which will be produced, the precursor solution may comprise additional components such as additives which are necessary for the proper functioning and performance of the resulting article. In the description below we will illustrate in detail the composition of the precursor solution for forming articles which are electrodes, battery separator coatings and membranes. The ingredients making up the precursor solution for different types of articles can be very different, provided one or more of the selected fluoropolymers of the invention are present in the composition making up the shaped article.

“Precursor solution”, in the present invention, is meant to indicate a composition which can be transformed into a shaped article, typically by removal of a solvent component, accompanied by a forming step. Such precursor solution includes a liquid phase comprising the selected fluoropolymer according to the invention in solubilized form into a suitable solvent. Depending on the article of which said precursor solution is precursor of, said precursor solution may include other liquid or solid components which may be present as additional solutes in said liquid phase comprising said selected fluoropolymers, or as additional liquid phases or as dispersed solids.

For example a precursor solution for an electrode coating, as known in the art, will comprise just a few percent by weight of selected fluoropolymer and a small amount of solvent, just enough to solubilize the polymer, while the bulk of the composition (typically over 50% by weight) is formed by dispersed powdery electro active materials and fillers.

On the other hand precursor solutions for making a membrane or a polymer coating may comprise the selected fluoropolymer and the solvent as major or, in the case of a coating, even the only constituents.

The reference to a “forming step” which typically is performed while and/or immediately after the solvent is removed has to be intended in a very broad sense, including a “passive” forming step wherein the precursor solution has essentially its final shape already while the solvent is removed e.g. when a film of precursor solution is cast on a substrate, or an electrode forming composition (which is a precursor solution according to the definition of this invention) is spread on a current collector. In this case the solvent is simply evaporated to convert the precursor solution into the shaped article, without applying any external force to give shape to the article. In other cases the forming step can be “active” e.g. when a cast film of precursor solution is dried, a mechanical action can force it to acquire a predetermined shape when drying as a solid e.g. as a formed sheet.

While the invention will be illustrated in detail when applied for making electrodes, battery separators coatings and membranes, it should however be understood that the basic principle underlying the invention and the relative advantages of improved mechanical properties, can be reapplied to any other article which can be obtained following the process of the invention in its broadest sense.

Once the precursor solution is formed an additional and subsequent step is to precipitate the polymer from the solution as a solid material, typically together with any required additives, if present, so to obtain a shaped article comprising the selected fluoropolymer of the invention. Precipitation of the polymer to form a certain type of shaped article can be obtained with any known technique typically used in the preparation of that type of article, such as e.g. evaporation of the solvent, preferably at a temperature between 6° and 95° C., or via phase inversion by addition of a non solvent. Precipitation of the polymer can be accompanied by the precipitation of other additives and components of the precursor solution.

The precipitation step which leads to the manufacture of a shaped article can be accompanied by additional steps which are conventional in the manufacture of said shaped article such as washing, forming, tensioning, stretching, calendering or other mechanical treatments.

The final step of the method of the invention is to thermally treat the shaped article formed in the previous step. An effect in terms of improved mechanical properties can be seen with a thermal treatment at a temperature of 100° C. or above for a time of 15 minutes or longer. As mentioned above the thermal treatment must be performed at a temperature comprised between 100° C. and the melting point of the lowest melting fluoropolymer which is present in the shaped article. While 15 minutes at 100° C. has been indicated as the minimum treatment at which an effect is measurable, it has been observed that longer treatment times and higher temperatures produce a stronger effect in increasing the mechanical properties of the reinforced shaped article of the invention. The thermal treatment is most effective at temperatures above 110° C. and when carried out for at least 1 hour or preferably at least 2 hours, more preferably for at least 3 hours. It has been found that increasing the temperature and the duration of the thermal treatment beyond a certain point only has a small effect on the properties of the reinforced article.

In general said thermal treatment is performed at a temperature between 10° and 150° C. preferably of 110 to 140° C. for a time of from for 1 to 16 hours, preferably 1 to 12 hours, more preferably from 2 to 8 hours, even more preferably from 3 to 6 hours.

A highly preferred thermal treatment is conducted at a temperature between 11° and 140° C., for a time of from 1 to 12, preferably from 2 to 8 hours even more preferably from 3 to 6 hours. It should be noted that lower temperature may achieve a similar effect than higher temperatures if the treatment last for longer. So that at 110° C. it is preferred to have a duration of 4-10 hours, while at 130° C. it is preferred to have a treatment duration of 2-6 hours. Treatment times longer than 6 hours at 130° C. or 10 hours at 110° C. are not detrimental to the properties of the reinforced shaped article, however do not provide further improvement and are therefore unnecessary.

It should be understood that a thermal treatment according to the invention can, in some cases, be performed immediately after the evaporation of the solvent. In fact in case a solvent is evaporated at a temperature of 100° C. or above, a step of thermal treatment according to the invention begins in the moment when the solvent has completed the evaporation i.e. when the shaped article is formed.

In general, it is expected that the original characteristics of the fluoropolymers are maintained in the shaped article obtained in step c), in particular it is preferred that, immediately before the begin of the thermal treatment, the selected one or more fluoropolymer of the invention have a gel content of less than 20%, preferably less than 10%, more preferably less than 5%, even more preferably less than 3% by weight based on the total amount of fluoropolymer, and preferably a molecular weight Mw of at least 200 KDalton, preferably at least 300 KDalton, more preferably at least 400 KDalton, even more preferably at least 500 KDalton, most preferably at least 600 KDalton, and at most 1400 KDalton, preferably at most 1300 KDalton, more preferably at most 1200 KDalton, even more preferably at most 1100 KDalton, most preferably of at most 1000 KDalton, when measured by GPC, using N, N-dimethylacetamide (DMA) as solvent, against monodisperse polystyrene standards.

In a further preferred embodiment, the shaped article of the invention, during the thermal treatment, is free from radical initiators and/or cross linkers, both residual from the polymerization reaction and added during manufacturing of the shaped article.

The invention will now be described in detail focusing on its application in manufacturing reinforced electrodes and reinforced filtration membranes.

A solvent-based electrode-forming composition (which is “precursor solution” according to the definition of the present invention) may be obtained by solubilizing the one or more selected fluoropolymers of the invention in powder form, in a polar organic solvent as described above, so as to obtain a binder solution, and by adding and dispersing into said binder solution a powdery electrode material (an active substance for a battery or an electric double layer capacitor), and optional additives, such as an electro-conductivity-imparting additive and/or a viscosity modifying agent. The resulting composition is typically in the form of a slurry and is a “precursor solution” according to the invention.

The polar organic solvents which can be used in this solvent-based electrode-forming composition and used for dissolving the selected fluoropolymers to provide the binder solution according to the present invention are the same solvents mentioned above in the general description as suitable solvents for the precursor solution.

For obtaining the binder solution of the selected fluoropolymers as above detailed, it is preferred to dissolve 0.1-15 wt. parts, particularly 1-10 wt. parts, of the selected fluoropolymers in 100 wt. parts of such an organic solvent. Below 0.1 wt. part, the polymer occupies too small a proportion in the solution, thus being liable to fail in exhibiting its performance of binding the powdery electrode material. Above 15 wt. parts, an abnormally high viscosity of the solution is obtained, so that the preparation of the electrode-forming composition becomes difficult.

In order to prepare the binder solution, it is preferred to dissolve the one or more fluoropolymers in an organic solvent at a temperature of 20-99° C., more preferably 25-95° C., further preferably 50-90° C. Below 25° C., the dissolution requires a long time and a uniform dissolution becomes difficult.

In the case of forming a positive electrode for a Lithium-ion secondary battery, said active substance (the powdery electrode material) may be selected from the group consisting of:
a composite metal chalcogenide of formula LiMQ₂, wherein M is at least one metal selected from transition metals such as Co, Ni, Fe, Mn, Cr and V or a metal such as Al and a mixture of thereof and Q is a chalcogen such as O or S. Among these, it is preferred to use a lithium-based composite metal oxide of formula LiMO₂, wherein M is the same as defined above. Preferred examples thereof may include LiCoO₂, LiNiO₂, LiNiₓCO₁₋ₓO₂ (0<x<1), LiNiₐCo_{b}Al_{c}O2 (a+b+c=1) and spinel-structured LiMn₂O₄.
a lithiated or partially lithiated transition metal oxyanion-based electro-active material of formula M₁M₂(JO₄)_{f}E_{1-f}, wherein M₁ is lithium, which may be partially substituted by another alkali metal representing less than 20% of the M₁ metals, M₂ is a transition metal at the oxidation level of +2 selected from Fe, Mn, Ni or mixtures thereof, which may be partially substituted by one or more additional metals at oxidation levels between +1 and +5 and representing less than 35% of the M₂ metals, including 0, JO₄ is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1. The M₁M₂(JO₄)_{f}E_{1-f} electro-active material as defined above is preferably phosphate-based and may have an ordered or modified olivine structure.

More preferably, the active substance in the case of forming a positive electrode has formula Li₃₋ₓM′_{y}M″_{2-y}(JO₄) 3 wherein 0≤x≤3, 0≤y≤2, M′ and M″ are the same or different metals, at least one of which being a transition metal, JO₄ is preferably PO₄ which may be partially substituted with another oxyanion, wherein J is either S, V, Si, Nb, Mo or a combination thereof. Still more preferably, the compound (AM) is a phosphate-based electro-active material of formula Li(FeₓMn₁₋ₓ)PO₄ wherein 0≤x≤1, wherein x is preferably 1 (that is to say, lithium iron phosphate of formula LiFePO₄).

In the case of forming a negative electrode for a lithium battery, active substance may be selected from the group consisting of:
carbonaceous materials (e.g. graphitic carbons) able to intercalate lithium, typically existing in forms such as powders, flakes, fibers or spheres (for example, mesocarbon microbeads) hosting lithium;
lithium metal;
lithium alloy compositions, including notably those described in U.S. Pat. No. 6,203,944 (3M INNOVATIVE PROPERTIES CO.) Mar. 20, 2001 and/or in WO 00/03444 (MINNESOTA MINING AND MANUFACTURING CO.) Jun. 10, 2005;
lithium titanates, generally represented by formula Li₄Ti₅O₁₂; these compounds are generally considered as “zero-strain” insertion materials, having low level of physical expansion upon taking up the mobile ions, i.e. Li⁺;
lithium-silicon alloys, generally known as lithium silicides with high Li/Si ratios, in particular lithium silicides of formula Li_{4.4}Si;
lithium-germanium alloys, including crystalline phases of formula Li_{4.4}Ge. In these embodiments the active substance may preferably comprise a carbonaceous material, such as graphite, activated carbon or a carbonaceous material obtained by carbonization of phenolic resin, pitch, etc. The carbonaceous material may preferably be used in the form of particles having an average diameter of ca. 0.5-100 μm.

An electro-conductivity-imparting additive may be added in order to improve the conductivity of a resultant composite electrode layer formed by applying and drying of the electrode-forming composition of the present invention, particularly in case of using an active substance, such as LiCoO₂, showing a limited electron-conductivity. Examples thereof may include: carbonaceous materials, such as carbon black, graphite fine powder and fiber, and fine powder and fiber of metals, such as nickel and aluminum.

The active substance for an electric double layer capacitor may preferably comprise fine particles or fiber, such as activated carbon, activated carbon fiber, silica or alumina particles, having an average particle (or fiber) diameter of 0.05-100 μm and a specific surface area of 100-3000 m²/g, i.e., having a relatively small particle (or fiber) diameter and a relatively large specific surface area compared with those of active substances for batteries.

The preferred electrode-forming compositions for positive electrodes comprises in terms of solids (i.e. excluding the solvent):
(a) one or more selected fluoropolymers, in a total amount from 1 to 10% wt, preferably from 2 to 9% wt, more preferably about 3% wt, with respect to the total weight (a)+(b)+(c);
(b) carbon black as electroconductivity-imparting additive, in an amount from 2 to 10% wt, preferably from 4 to 6% wt, more preferably about 5% wt, with respect to the total weight (a)+(b)+(c);
(c) a powdery electrode material, preferably a composite metal chalcogenide represented by a general formula of LiMQ₂, as above detailed, in an amount from 80 to 97% wt, preferably from 85 to 94% wt, more preferably about 92% wt.

In order to manufacture an electrode, the precursor solution, in the form of a slurry is typically applied by any suitable procedures such as casting, printing or roll coating onto at least one surface of a suitable metal substrate (typically a flat metal sheet) thereby providing an assembly comprising a metal substrate coated with the precursor solution onto at least one surface. The assembly is then dried removing the solvent and precipitating the fluoropolymers in solid form thereby providing an electrode coating which is a “shaped article” not yet reinforced according to the invention. The drying step is typically carried out at a temperature comprised between 50° C. to 99° C., preferably between 80° C. to 95° C., for a time of between 5 minutes and 5 hours, preferably between 30 minutes and 2 hours, typically at about 90° C. for 50 minutes.

The electrode coating can be subject to additional conventional steps such as calendering and hot pressing, typically at 80° C. as known in the art.

Following the drying step the electrode coating thus obtained (a “shaped article” within the meaning of the present invention) is then subject to the thermal treatment of the invention thereby converting it to the reinforced shaped article of the invention. The thermal treatment can be a separate independent step or it can be an extension of the drying process wherein, once the solvent is removed and the “shaped article” is formed, said shaped article is exposed to a temperature as required by the invention for a sufficient time to obtain the claimed effect. The duration of the thermal treatment is calculated as starting when the solvent removal is complete.

Preferably, for an electrode forming composition, the thermal treatment is performed at a temperature between 100° C. and 150° C. and for a time of from 50 minutes to 24 hours. Exemplary effective thermal treatments were 130° C. for 3 h, 110° C. for 3 h. All thermal treatments for electrodes are preferably performed under vacuum.

When applied onto an electrode coating the thermal treatment of the invention has been found to provide, surprisingly, an increased adhesion of the coating onto the metal substrate, with respect a coating of the same material not subject to the thermal treatment of the invention.

Another shaped article which can be manufactured and reinforced using the method of the present invention is a membrane.

The term “membrane” is used herein in its usual meaning, that is to say it refers to a discrete, generally thin, interface that moderates the permeation of chemical species in contact with it. This interface may be molecularly homogeneous, that is, completely uniform in structure (dense membrane), or it may be chemically or physically heterogeneous, for example containing voids, holes or pores of finite dimensions (porous membrane).

Porous membranes are generally characterized by pore size distribution, the average pore diameter and the porosity, i.e. the volume fraction of the total membrane that is porous.

Membranes having a uniform structure throughout their thickness are generally known as symmetrical membranes, which can be either dense or porous; membranes having pores which are not homogeneously distributed throughout their thickness are generally known as asymmetric membranes. Asymmetric membranes are characterized by a thin selective layer (0.1-1 μm thick) and a highly porous thick layer (100-200 μm thick) which acts as a support and has little effect on the separation characteristics of the membrane.

Membranes can be in the form of a flat sheet or in the form of tubes. Tubular membranes are classified based on their dimensions in tubular membranes having a diameter greater than 3 mm; capillary membranes, having a diameter comprised between 0.5 mm and 3 mm; and hollow fibers having a diameter of less than 0.5 mm. Often times capillary membranes are also referred to as “hollow fibers”.

Flat sheet membranes are generally preferred when high fluxes are required whereas hollow fibers are particularly advantageous in applications where compact modules with high surface areas are required. Depending on their applications membranes may also be supported to improve their mechanical resistance. The support material is generally selected to have a minimal influence on the selectivity of the membrane. Said support material may be any of non-woven materials, glass fibers and/or polymeric materials such as for example polypropylene, polyethylene, polyethylene terephthalate.

A method of making a reinforced shaped article according to the present invention wherein said shaped article is a membrane typically includes the steps of:
providing said one or more fluoropolymers selected according to the invention,
dissolving said fluoropolymer in a suitable solvent and forming a precursor solution (typically called, in the field of membranes “dope solution”), said precursor solution also comprising optionally, one or more pore forming agents and other optional additives such as salts, fillers as known in the art;
processing said precursor solution into a film; and
immersing said film in a non-solvent bath thus precipitating said fluoropolymers thus forming a membrane which is a shaped article according to the invention.

Typically membranes produced following this process are then washed to fully remove residual solvents and additives and may be subject to one or more stretching steps.

As a further step the membrane thus obtained (typically after washing and/or if necessary stretching) is subject to a thermal treatment as described so to obtain a reinforced membrane which is a reinforced shaped article according to the invention. The thermal treatment can be accomplished keeping the membrane under tension or being stretched.

The polar organic solvent used in the method above is one or more of those mentioned above in the general list of solvents. Preferably for membranes the solvent may be one or more than one of: N-methyl-2-pyrrolidone, N-butyl pyrrolidone, dimethylformamide, N,N-dimethylacetamide, N,N-dimethylsulfoxide, hexamethylphosphamide, dioxane, tetrahydrofuran, tetramethylurea, dihydrolevoglucosenone (Cyrene®), triethyl phosphate, and trimethyl phosphate; or one or more diesters of formula (I-_{de}), esteramides of formula (I-ₑₐ) and diamides of formula (I-_{da}) as described above.

Pore forming agents are generally selected among compounds which have solubility in the polar organic solvent and in the non-solvent bath, So that they will be at least partially removed from the membrane which will be formed, providing for porosity.

It is generally understood that while inorganic compounds like lithium chloride can be used, as well as monomeric organic compounds, including maleic anhydride, polymeric pore forming agents are generally preferred. In particular, the polymeric pore forming agent is preferably selected from the group consisting of poly(alkylene oxide) and derivatives thereof (POA) and polyvinylpyrrolidone (PVP).

The poly(alkylene oxide) (PAO) are polymers obtained from polymerizing alkylene oxides including ethylene oxide, propylene oxide and mixtures thereof.

Derivatives of PAO can be obtained by reacting hydroxyl end groups thereof with suitable compounds, so as to generate notably ether groups, in particular alkyl ethers, ester groups, for instance acetates and the like. Nevertheless, PAO having hydroxyl end groups are generally used. Among PAO, polyethylene oxide (PEO or PEG) polymers are particularly preferred.

The polyvinylpyrrolidone (PVP) is generally a homopolymer, although copolymers of vinylpyrrolidone with other monomers can be advantageously used, said monomers being generally selected from the group consisting of N-vinylcaprolactam, maleic anhydride, methylmethacrylate, styrene, vinyl acetate, acrylic acid, dimethylaminoethylmethacrylate. Nevertheless PVP homopolymers are generally employed.

Molecular weight of PVP is not particularly limited. It is nevertheless understood that relatively high molecular weight of PVP are preferred to the sake of processing the precursor solution into a membrane. Hence the K value of the PVP, universally recognized as suitable measure of its molecular weight, is generally of at least 10.

When used, the total amount of pore forming agents is generally comprised between 0.1 and 5% wt, preferably between 0.5 and 3.5% wt based on the total weight of the precursor solution.

The precursor solution for preparing a membrane can be prepared by any conventional manner. The precursor solution is typically prepared at a temperature of at least 25° C., preferably at least 30° C., more preferably at least 40° C. and even more preferably at least 50° C. The precursor solution is typically prepared at a temperature of less than 99° C., preferably less than 95° C.

The overall concentration of the selected fluoropolymers in the precursor solution should be at least 8% by weight, preferably at least 10% by weight, more preferably at least 12% by weight, based on the total weight of the precursor solution. Typically the concentration of the selected fluoropolymers in the solution does not exceed 50% by weight, preferably it does not exceed 40% by weight, more preferably it does not exceed 30% by weight, based on the total weight of the precursor solution.

The mixing time required to obtain the precursor solution can vary widely depending upon the rate of solution of the components, the temperature, the efficiency of the mixing apparatus, the viscosity of the precursor solution being prepared, and the like.

Any suitable mixing equipment may be used. Preferably, the mixing equipment is selected to reduce the amount of air entrapped in the precursor solution which may cause defects in the final membrane. The mixing of the selected fluoropolymers and the polar organic solvent may be conveniently carried out in a sealed container, optionally held under an inert atmosphere. Inert atmosphere, and more precisely nitrogen atmosphere has been found particularly advantageous for the preparation of precursor solutions comprising PVP.

As mentioned above in a subsequent step the precursor solution is processed into a film.

The term “film” is used herein to refer to the layer of precursor solution obtained after the processing of the same. Depending on the final form of the membrane the film may be either flat, when flat membranes are required, or tubular in shape, when tubular or hollow fiber membranes are to be obtained.

Conventional techniques can be used for processing the precursor solution into a film, being understood that casting techniques are preferred. Different casting techniques are used depending on the final form of the membrane to be manufactured. When the final product is a flat membrane the polymer solution is cast as a film over a flat support, typically a plate, a belt or a fabric, or another microporous supporting membrane, by means of a casting knife a draw-down bar ore, preferably, a slot die.

Accordingly, in its first embodiment the method of the invention comprises a step of casting the precursor solution into a flat film on a support. Hollow fibers and capillary membranes can be obtained by the so-called wet-spinning process. In such a process the precursor solution is generally pumped through a spinneret, that is an annular nozzle comprising at least two concentric capillaries: a first outer capillary for the passage of the precursor solution and a second inner one for the passage of a supporting fluid, generally referred to as “lumen”. The lumen acts as the support for the casting of the precursor solution and maintains the bore of the hollow fiber or capillary precursor open. The lumen may be a gas, or, preferably, a liquid at the conditions of the spinning of the fiber. The selection of the lumen and its temperature depends on the required characteristics of the final membrane as they may have a significant effect on the size and distribution of the pores in the membrane. In general the lumen is not a strong non-solvent for the selected fluoropolymers or, alternatively, it contains a solvent or weak solvent for said fluoropolymers. The lumen is typically miscible with the non-solvent and with the polar organic solvent of the selected fluoropolymers.

At the exit of the spinneret, after a short residence time in air or in a controlled atmosphere, the hollow fiber or capillary precursor is immersed in the non-solvent bath wherein the fluoropolymers precipitate forming the hollow fiber or capillary membrane.

Accordingly, in its second embodiment the process of the invention comprises a step of casting the precursor solution into a tubular film around a supporting fluid.

The casting of the polymer solution is typically done through a spinneret. The supporting fluid forms the bore of the final hollow fiber or capillary membrane. When the supporting fluid is a liquid, immersion of the fiber precursor in the non-solvent bath also advantageously removes the supporting fluid from the interior of the fiber.

Tubular membranes, because of their larger diameter, are produced using a different process from the one employed for the production of hollow fiber membranes.

In its third embodiment the process of the invention comprises a step of casting the polymer solution into a tubular film over a supporting tubular material.

After the processing of the precursor solution has been completed so as to obtain a film, in whichever form, as above detailed, said film is immersed into a non-solvent bath. This step is generally effective for inducing the precipitation of the selected fluoropolymers from the precursor solution. The precipitated fluoropolymers thus forms the final membrane structure.

As used herein the term “non-solvent” is taken to indicate a substance incapable of dissolving a given component of a solution or mixture. Suitable non-solvents for the selected fluoropolymers of the invention are water and aliphatic alcohols, preferably, aliphatic alcohols having a short chain, for example from 1 to 6 carbon atoms, more preferably methanol, ethanol and isopropanol. Blends of said preferred non-solvents, i.e. comprising water and one or more aliphatic alcohols can be used. Preferably, the non-solvent of the non-solvent bath is selected from the group consisting of water, aliphatic alcohols as above defined, and mixture thereof. Further in addition, the non-solvent bath can comprise in addition to the non-solvent (e.g. in addition to water, to aliphatic alcohol or to mixture of water and aliphatic alcohols, as above detailed) small amounts (typically of up to 40% wt, with respect to the total weight of the non-solvent bath, generally 25 to 40% wt)) of a solvent for the selected fluoropolymers. Use of solvent/non-solvent mixtures advantageously allows controlling the porosity of the membrane. The non-solvent is generally selected among those miscible with the polar organic solvent used for the preparation of the precursor solution. Preferably the non-solvent in the process of the invention is water. Water is the most inexpensive non-solvent and it can be used in large amounts.

When used, the pore forming agent is generally at least partially, if not completely, removed from the membrane in the non-solvent bath. Once removed from the precipitation bath the membrane may undergo additional treatments, for instance rinsing, in some cases rinsing with sodium hypochlorite solutions is performed in order to remove PVP pore forming agents more completely. The membrane is then typically dried, or stored in a water bath.

As further step the membrane thus obtained (the shaped article of the invention) is thermally treated as required to produce a reinforced membrane which is a reinforced shape article according to the present invention.

The invention further pertains to a membrane obtained by the method as above described.

The membrane obtained from the process of the invention is preferably a porous membrane. Typically the membrane has an asymmetric structure. The porosity of the membrane may range from 3 to 90%, preferably from 5 to 80%.

The pores may have an average diameter of at least 0.001 μm, of at least 0.005 μm, of at least 0.01 μm, of at least 0.1 μm, of at least 1 μm, of at least 10 μm and of at most 50 μm.

Should the disclosure of any patents, patent applications, and publications which are incorporated herein by reference conflict with the description of the present application to the extent that it may render a term unclear, the present description shall take precedence.

The invention is described hereunder in more detail with reference to the following examples, which are provided with the purpose of merely illustrating the invention, with no intention to limit its scope.

### Experimental Section

Determination of average molecular weight Molecular weight was measured by GPC. The polymer in powder form was dissolved in DMA at 0.25 g/100 ml in DMA in the presence of LiBr at a concentration of 0.01N in the solution, at 45° C., under stirring for two hours. After dissolution the solution was centrifuged at 20000 rpm for 60 minutes at room temperature using a Sorvall RC-6 Plus centrifuge (rotor model: F21S-8X50Y).

The supernatant of each sample was analyzed using instrumentation and conditions below detailed:
Mobile phase: DMA
Flow rate: 1 mL/min.
Temperature: 45° C.
Injection system: Waters 717plus Autosampler.
Injection volume: 200 μL.
Pump: Waters Isocratic Pump model 515.
Columns: Four Water Styragel HT (300×7.5) mm, 10 μm particle size:
Styragel HT-6, HT-5, HT-4, HT-3 with guard column.
Detector: Waters refractive index model 2414.
Software for data acquisition and processing: Waters Empower.

The method produces a curve representing the quantitative molecular weight from which both Mn (number average) and Mw (weight average) values can be calculated.

### Determination of Insoluble Gel Content

A solution of fluoropolymer is produced and centrifuged as described above in the method for “Determination of average molecular weight”. After removal of the supernatant (used in the GPC method) a precipitated residue is left in the vial. Gels content was determined by weighing the said residue, after drying at a temperature of 150° C. for 48 hours, and dividing the same by the overall weight of the polymer sample specimen.

### Mechanical Properties

Mechanical properties of the membranes were assessed at room temperature (23° C.) following ASTM D 638 standard procedure (type V, grip distance=25.4 mm, initial length Lo=21.5 mm). Five specimen of each sample were tested immediately after being taken off from demineralized water used for storage.

### Permeability Measurement for Membranes

Permeability of membranes has been measured as Water flux (J). This is defined as the volume which permeates through a membrane per unit area and per unit time at a given pressure.

The water flux (J) is calculated with the following equation:

$$J = \frac{V}{A Δ T}$$

wherein:
   V (in liters) is the volume of permeate,
   A (in m²) is the membrane area, and
   ΔT (in hours) is the operation time.

Water flux measurements were conducted at room temperature using a dead-end configuration under a constant nitrogen pressure of 1 bar using pure MilliQ water. Membrane discs with an effective area of 11.3 cm2 were cut from the membrane sheets (stored in water) and placed on a metal grid. For each material, flux is the average of at least five different discs. The flux is expressed in LMH (liters/squared meter×hour).

### Adhesion Measurement (for Electrode Forming Composition)

Adhesion Peeling Force between Aluminium foil and Electrode forming composition:

180° peeling tests were performed following the setup described in the standard ASTM D903 at a speed of 300 mm/min at 20° C. in order to evaluate the adhesion of the dried coating layer to the Al foil.

### Preparation of Fluoropolymer F1

The fluoropolymer F1 used in the examples is a copolymer of VDF with acrylic acid having 0.3% by moles of acrylic acid. The polymer was prepared as follows:

In a 21 It. horizontal reactor autoclave equipped with baffles and stirrer working at 50 rpm, 13.4 It. of deionized water were introduced. The temperature was brought to 80° C., 100 ml of a 29.4 g/l aqueous solution of potassium iodide (KI) was then added and the pressure of 38 Bar abs was maintained constant throughout the whole polymerization reaction by feeding VDF gaseous monomer. Once the pressure was reached 250 ml of a 100 g/l aqueous solution of ammonium persulfate (APS) were added over a period of 20 minutes then and additional amount of APS solution was continuously added at a flux rate of 60 ml/h for the whole duration of the polymerization; in addition, 50 ml of a solution of acrylic acid (AA) (50 g/l of acrylic acid in water) were fed every 250 g of monomer consumed.

When 4500 g of the VDF were fed, the gaseous feeding was interrupted, then the pressure was let to fall down up to 4 bar while keeping the reaction temperature constant. Final reaction time was 270 min. The reactor was cooled to room temperature and latex was recovered. The final ratio (KI)/APS was 0.084 mol/mol.

The aqueous latex so obtained had a solid content of 25.2% by weight. The VDF-AA polymer was dispersed in the aqueous latex under the form of particles having an average primary size of 251 nm, as measured according to ISO 13321.

The VDF-AA polymer was recovered freezing 250 ml of latex for 48 h and then unfreezing it and the obtained powder was rinsed and dried at 70° C. for 12 h. The obtained VDF-AA polymer contains 0.3% by moles of acrylic acid (AA) monomer and possess a melting point of 160.8° C. (determined according to ASTM D3418) a melt viscosity MV (230° C./100 sec⁻¹) of 57.9 kPoise, an average molecular weight Mn of 254 kDalton and Mw of 871 kDalton, a gel content of <3% and a content of end groups as follows: —CF2H: 20 mmol/kg; —CF2-CH3: 14 mmol/kg; —CH2OH: 5 mmol/kg; —CH2I: 2 mmol/kg. The iodine atoms amount per polymer chain is 0.5.

### Example 1—Manufacture of a Reinforced Electrode

This example describes the preparation of a reinforced shaped article according to the present invention wherein said reinforced shaped article is a reinforced electrode, having improved adhesion between the electrode active material and the metallic current collector (Al foil).

### Materials Used:

Active material: Lithium Nickel Manganese Cobalt Oxide
LiNi_{0.6}Mn_{0.2}Co_{0.2}O₂ (NMC622).
Fluoropolymer: F1 as described above
Conductive material: Carbon black SC-65

A first dispersion was prepared by pre-mixing for 10 minutes in a centrifugal mixer 34.7 g of a 6% by weight solution of fluoropolymer in NMP, 133.8 g of NMC622, 2.8 g of SC-65 and 8.8 g of additional NMP.

The mixture was then mixed using a high speed disk impeller at 2000 rpm for 50 minutes. Additional 7.2 g of NMP were subsequently added to the dispersion, which was further mixed with a butterfly type impeller for 20 minutes at 1000 rpm.

Positive electrodes (a “shaped article” according to the invention) were obtained by casting the as obtained compositions on 15 μm thick Al foil with doctor blade and drying the coated layers in a vacuum oven at temperature of 90° C. for about 50 minutes. The thickness of the dried coating layers was about 110 μm.

The resulting shaped article contain 1.5% by weight of polymer, 2% by weight of conductive additive and 96.5% by weight of active material NMC622.

The electrode thus obtained was then thermally treated at 110° C. for 3 hours in an oven under vacuum, thus forming a reinforced electrode (a “reinforced shaped article” according to the invention).

### Example 2—Manufacture of a Reinforced Electrode

The same procedure of Ex. 1 was followed except that the thermal treatment was at 130° C. for 1 hour.

### Example 3—Manufacture of a Reinforced Electrode

The same procedure of Ex. 1 was followed except that except that the thermal treatment was at 130° C. for 3 hours.

### Example 4—Manufacture of a Reinforced Electrode

The same procedure of Ex. 1 was followed except that except that the thermal treatment was at 130° C. for 16 hour.

### Comparative Example 5—Manufacture of an Electrode

The same procedure of Ex. 1 was followed except that no thermal treatment was performed.

### Example 6—Manufacture of a Reinforced Electrode

The same procedure of Ex. 1 was followed except that LiCoO₂ (LCO) was used instead of NMC622.

### Example 7—Manufacture of a Reinforced Electrode

The same procedure of Ex. 2 was followed except that LiCoO₂ (LCO) was used instead of NMC622.

### Example 8—Manufacture of a Reinforced Electrode

The same procedure of Ex. 3 was followed except that LiCoO₂ (LCO) was used instead of NMC622.

### Example 9—Manufacture of a Reinforced Electrode

The same procedure of Ex. 4 was followed except that LiCoO₂ (LCO) was used instead of NMC622.

### Comparative Example 10—Manufacture of an Electrode

The same procedure of Comparative Ex. 5 was followed except that LiCoO₂ (LCO) was used instead of NMC622.

### Adhesion Data for Electrodes.

TABLE 1

| | Thermal treatment | Adhesion (N/m) |
|---|---|---|
| Example 1 | 110° C. 3 h | 88 |
| Example 2 | 130° C. 1 h | 103 |
| Example 3 | 130° C. 3 h | 111 |
| Example 4 | 130° C. 16 h | 119 |
| Comparative | None | 69 |
| Example 5 | | |
| Example 6 | 110° C. 3 h | 98 |
| Example 7 | 130° C. 1 h | — |
| Example 8 | 130° C. 3 h | 121 |
| Example 9 | 130° C. 16 h | 122 |
| Comparative | None | 60 |
| Example 10 | | |

The data of Table 1 show that the reinforced electrodes manufactured according to the invention, including the thermal treatment step, have a much higher adhesion to the metal substrate than the same electrodes manufactured without the thermal treatment step.

### Example 11—Manufacture of a Reinforced Membrane

### Materials Used:

Fluoropolymer: F1 as described above
N,N-dimethylacetamide (DMAC) obtained from Sigma Aldrich
Polyethyleneglycol (PEG) 200 obtained from Sigma Aldrich
Polyvinylpirrolidone (PVP) K10 obtained from Sigma Aldrich
Isopropyl alcohol (IPA) obtained from Sigma Aldrich

### Precursor (Dope) Solution Preparation:

A dope solution for porous membrane manufacturing was prepared by adding 15 g Fluoropolymer 1, 10 g of PEG 200 and 10.5 g of PVP to 64.5 of DMAC and stirring with a magnetic stirrer at 65° C. until complete dissolution.

### Membrane Preparation:

An A4 size flat sheet porous membranes was prepared by filming the dope solution described above, over a suitable smooth glass support by means of an automatized casting knife. Membrane casting was performed by keeping dope solutions, the casting knife and the support temperatures at 25° C., in order to prevent premature precipitation of the polymer. The knife gap was set to 250 μm. After casting, the polymeric film was immediately immersed in a coagulation bath in order to induce phase inversion. The coagulation bath consisted of pure de-ionized water. After coagulation the membrane was washed several times in pure water to remove residual traces of solvent. After washing the membrane was thermally treated in an over under atmospheric pressure at 130° C. for 6 hours. The membrane were always stored (wet) in water both before and after the thermal treatment.

### Comparative Example 12—Manufacture of a Non-Reinforced Membrane

The same procedure for Ex. 11 was followed except that the membrane was not thermally treated.

### Mechanical Properties

TABLE 2

| | Thermal | | Stress at | Flux |
|---|---|---|---|---|
| | treatment | Modulus | Br. | (LMH at |
| | 130° C. 6 h | (MPa) | (MPa) | 1 bar) |
| Ex 11 | YES | 46 | 1.50 | 300 |
| C. Ex 12 | NO | 23 | 1.16 | 800 |

The data of Table 2 show that a membrane manufactured according to the invention, including the thermal treatment step, has improved mechanical properties with respect to the same membrane manufactured without the thermal treatment step.

It has been observed that the membranes tend to shrink during the thermal treatment. The flux data also indicate that the reinforced membranes have a lower flux than the non reinforced membranes. The flux of the reinforced membrane is anyhow sufficiently high for conventional applications. Without being bound by theory we believe that the reduction in flux may be connected with the shrinkage which causes a corresponding reduction of pore size. It is expected that wetting membranes with glycerol or other wetting agents before the thermal treatment may reduce shrinkage and consequently reduce the loss in flux. Also it is expected that performing the thermal treatment while keeping the membrane under tension, may also reduce the loss in flux capacity, especially for tubular membranes.

1. A method of making a reinforced shaped article said method comprising the steps of:
a) providing one or more fluoropolymers having a melting point Tm, said one or more fluoropolymers being characterized in that they:
(i) comprise more than 30% by moles of recurring units derived from VDF, with respect to the total number of recurring units of the polymer;
(ii) have iodine-containing chain ends —CH₂I in an amount of from 0.1 to 0.9 per chain;
b) dissolving said fluoropolymer in a suitable solvent and forming a precursor solution
c) precipitating said one or more fluoropolymers as a solid from said precursor solution thereby obtaining a shaped article comprising said one or more fluoropolymers
e) thermally treating said shaped article for at least 15 minutes at a temperature comprised between 100° C. and a lowest melting point Tm of said one or more fluoropolymers thereby obtaining said reinforced shaped article.

2. The method of claim 1 wherein said one or more fluoropolymers comprise more than 50% by moles of recurring units derived from VDF, with respect to the total number of recurring units of the polymer.

3. The method of claim 1 wherein said one or more fluoropolymers have iodine-containing chain ends —CH₂I in an amount of 0.3 to 0.7 per chain.

4. The method of claim 1 wherein said one or more fluoropolymers have a weight averaged molecular weight (Mw) of at least 200 KDalton, and at most 1400 KDalton, when measured by GPC, using N,N-dimethylacetamide (DMA) as solvent, against monodisperse polystyrene standards.

5. The method of claim 1 wherein said one or more fluoropolymers comprise recurring units derived from monomers comprising at least one polar group selected from the group consisting of hydroxyl groups, carboxylic acid groups, epoxy groups.

6. The method of claim 1 wherein said one or more fluoropolymers comprise recurring units derived from (meth)acrylic monomers in an amount of at least 0.1%, and/or at most 10%, by moles with respect to the total number of recurring units of the polymer.

7. The method of claim 1 wherein said one or more fluoropolymers comprise a fraction of insoluble gels, as measured with the insoluble gel content test described herein, below 20% by weight based on the total weight of said one or more fluoropolymers.

8. The method of claim 1 wherein said one or more fluoropolymers have been manufactured with a polymerization method comprising an emulsion polymerization reaction in an aqueous environment in the presence of one or more radical initiators and one or more iodine containing chain transfer agents.

9. The method of claim 8 wherein said emulsion polymerization reaction is carried out with a molar ratio between said radical initiator and said iodine containing chain transfer agent of at most 0.12 and of at least 0.015.

10. The method of claim 8 wherein said emulsion polymerization reaction is carried out with no addition of fluorinated surfactants.

11. The method of claim 1 wherein said suitable solvent is selected from the group consisting of:
N-methyl-2-pyrrolidone, N-butyl pyrrolidone, dimethylformamide, N,N-dimethylacetamide, N,N-dimethylsulfoxide, dihydrolevoglucosenone, hexamethylphosphamide, dioxane, tetrahydrofuran, tetramethylurea, triethyl phosphate, trimethyl phosphate,
diesters of formula (I-_{de}), esteramides of formula (I-ₑₐ) and diamides of formula (I-_{da}):
R¹(O═)CO-A_{de}-OC(═O)R² (I-_{de})
R¹O(O═)C-Aₑₐ-C(═O)NR³R⁴ (I-ₑₐ)
R⁵R⁶N(O═)C-A_{da}-C(═O)NR⁵R⁶ (I-_{da})
wherein:
R¹ and R², equal to or different from each other, are independently selected from the group consisting of C₁-C₂₀ hydrocarbon groups;
R³, R⁴, R⁵ and R⁶, equal to or different from each other, are independently selected from the group consisting of hydrogen, C₁-C₃₆ hydrocarbon groups, optionally substituted, being understood that R³, R⁴, R⁵ and R⁶ are optionally part of a cyclic moiety including the nitrogen atom to which they are bound, said cyclic moiety being optionally substituted and/or optionally comprising one or more than one additional heteroatoms,
A_{de} is a C₃-C₁₀ divalent alkylene group comprising one or more ether oxygen atoms,
Aₑₐ and A_{da}, equal to or different from each other, are independently C₃-C₁₀ divalent alkylene groups, optionally comprising one or more ether oxygen atoms and/or one or more functional side groups;
or mixtures thereof.

12. The method of claim 1 wherein thermally treating said shaped article is performed at a temperature between 100 and 150° C. for a time of from 1 to 16 hours.

13. The method of claim 1 wherein said one or more fluoropolymer, when comprised within said shaped article, before thermally treating said shaped article, comprise a fraction of insoluble gels, as measured with the insoluble gel content test described herein, below 20% by weight based on the total weight of said one or more fluoropolymers, and a molecular weight Mw of at least 200 KDalton and at most 1400 KDalton, when measured by GPC, using N, N-dimethylacetamide (DMA) as solvent, against monodisperse polystyrene standards.

14. A reinforced shaped article obtained with the method of claim 1 wherein said shaped article is an electrode coating.

15. A reinforced shaped article obtained with the method of claim 1 wherein said shaped article is a filtration membrane.
